(19) United States
(12) Patent Application Publication
(10) Pub. No.: US 2025/0376135 A1
(43) Pub. Date: Dec. 11, 2025

(54) BALL BEARING TRAILER JACK

(71) Applicant: Harrison Michael Grimm, Mars, PA (US)

(72) Inventor: Harrison Michael Grimm, Mars, PA (US)

(21) Appl. No.: 18/735,388

(22) Filed: Jun. 6, 2024

(51) Int. Cl. B60S 9/18; B60S 9/22

(52) U.S. Cl. CPC B60S 9/18; B60S 9/22

(57) ABSTRACT

The present invention pertains to a trailer jack apparatus designed to facilitate the support and maneuvering of trailers. Specifically, the invention introduces a trailer jack equipped with a high-strength ball bearing at the point of ground contact, enhancing stability, durability, and ease of use during trailer hitching and unhitching processes.

### BACKGROUND OF THE INVENTION

The present invention relates trailer jacks and, more particularly, to a trailer jack comprising a high strength ball bearing at the ground contact point.

Trailer jacks are essential components utilized in the coupling and decoupling of trailers from towing vehicles. Traditional trailer jacks often feature a single wheel at the contact point with the ground, leading to frictional resistance and potential wear over time.

Such conventional trailer jacks may encounter challenges in maneuvering the trailer effectively. The wheel design, while providing certain mobility, can be difficult to control and navigate precisely, particularly in tight spaces or when attempting to position the trailer accurately. Moreover, conventional wheels are prone to sinking into soft or uneven surfaces, further complicating the maneuvering process, and potentially causing damage to the trailer or towing vehicle.

Users often succumb to kicking the wheel of the conventional trailer jack in an attempt to align the trailer in the direction desired which is often difficult and can cause injury to one's foot especially when the trailer is carrying a load.

Recognizing these limitations, there exists a need for an improved trailer jack design that offers enhanced stability, maneuverability, and durability, addressing shortcomings associated with conventional wheel-based systems.

The present invention significantly improves the mobility of the trailer by giving it 360 degrees of movement. This allows the user ease of properly aligning the trailer hitch with the receiver for safe and secure transport. It reduces the risk of error and injury while trailering.

### SUMMARY OF THE INVENTION

In one aspect of the present invention, the present invention introduces a novel trailer jack incorporating a high-strength ball bearing at the ground contact point. This innovative feature allows for smoother rotation and maneuverability of the trailer jack, reducing frictional resistance and enhancing overall stability. The use of a high-strength ball bearing ensures durability and longevity, even under demanding conditions.

The introduction of a high-strength ball bearing at the ground contact point represents a significant advancement in trailer jack technology, providing a smoother and more controlled means of supporting and maneuvering trailers across various terrains and loading conditions.

These and other features, aspects and advantages of the present invention will become better understood with reference to the following drawings, description, and claims.

### BRIEF DESCRIPTION OF THE DRAWINGS

FIG. 1 is perspective view of a trailer jack in accordance with a preferred embodiment of the present invention; and

FIG. 2 is a side view thereof.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

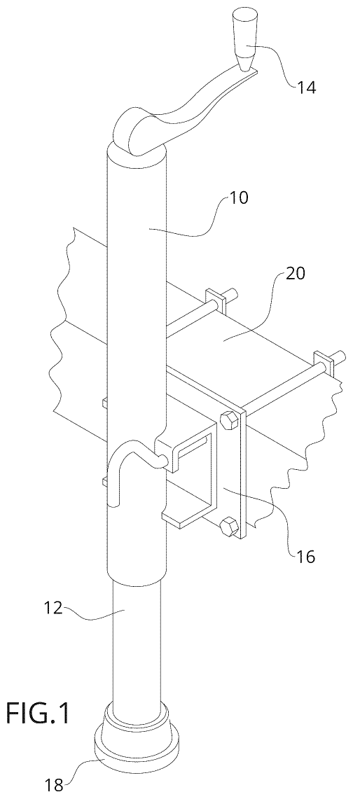

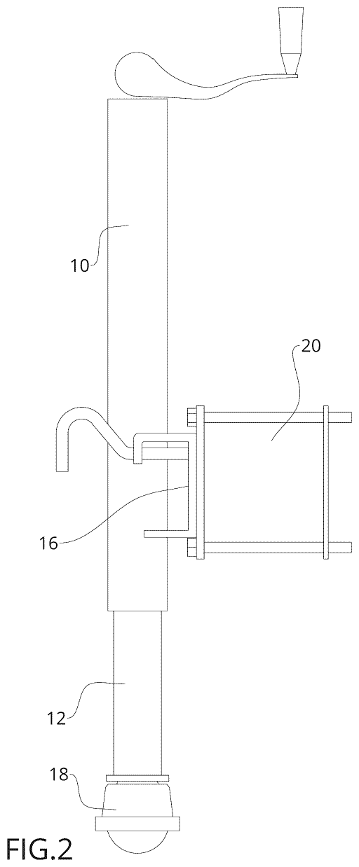

Broadly, as described herein, and as seen in FIGS. 1 and 2 hereto, an embodiment of the present invention provides a trailer jack comprises a top cylinder 10, a bottom cylinder 12, a crank mechanism 14, and a ball bearing 18 at the ground contact point. The trailer jack further includes a mounting plate 16 for attaching the jack to a trailer 20.

The high-strength ball bearing 18 is securely mounted within a recess at the lower end of the bottom cylinder 12 and provides a smooth and low-friction interface with the ground surface. The ball bearing is constructed from durable materials, such as hardened steel or ceramics, to withstand heavy loads and repetitive use.

In operation, the user activates the crank mechanism 14 to lower or raise the trailer jack, allowing for convenient coupling or decoupling of the trailer 20 from the towing vehicle (not shown). The presence of the high-strength ball bearing 18 at the ground contact point ensures improved rotation and maneuverability of the trailer 20, thereby improving operational efficiency and reducing wear on the trailer jack and its components.

As one of skill in the art understands, the movement of conventional trailer jacks is severely limited which can make connecting a trailer very difficult. Getting a trailer hitch to align with the receiver is paramount to safely coupling and securing the load.

The present invention significantly improves the mobility of the trailer by giving it 360 degrees of movement. This allows the user ease of properly aligning the trailer hitch with the receiver for safe and secure transport. It reduces the risk of error and injury while trailering.

The trailer jack mounts securely to trailer 20 via the mounting plate 16 and four bolts with lock nuts (by way of example). The crank 14 of the trailer jack works to raise and lower the trailer via the screw gear linkage to the desired height while the ball bearing works to roll the trailer with 360 degrees of motion to the precise location in order to properly and safely lower the trailer via the crank onto the trailer hitch receiver of the vehicle.

A brake could be added for additional security to prevent the trailer from rolling inadvertently. The trailer jack can also be used with or without the crank as the most useful portion of this invention is the ball bearing for full 360 degrees of movement.

It should be understood, of course, that the foregoing relates to exemplary embodiments of the invention and that modifications may be made without departing from the spirit and scope of the invention as set forth in the following claims.

What is claimed is:

1. A trailer jack apparatus comprising:
a top cylinder, and
a bottom cylinder having a ground contact point equipped with a high-strength ball bearing.

2. The trailer jack apparatus of claim 1, wherein the high-strength ball bearing is constructed from hardened steel or ceramics.

3. The trailer jack apparatus of claim 1, further comprising a mounting plate for attaching the trailer jack to a trailer.

4. The trailer jack apparatus of claim 1, wherein the top cylinder further comprises a crank mechanism for lowering and raising the trailer during trailer hitching and unhitching processes.

5. The trailer jack apparatus of claim 4, wherein the high-strength ball bearing facilitates smooth rotation and maneuverability during trailer hitching and unhitching processes.
